(19) United States
(12) Patent Application Publication
(10) Pub. No.: US 2017/0052681 A1
(43) Pub. Date: Feb. 23, 2017

(54) Systems and Methods for Preserving and Transmitting Interfaces Displayed at Communication Devices

(71) Applicant: MASTERCARD INTERNATIONAL INCORPORATED, Purchase, NY (US)

(72) Inventors: Timothy Higgins, O'Fallon, MO (US); Scott J. Pardo, St. Peters, MO (US); Ping X. Chen, Chesterfield, MO (US)

(21) Appl. No.: 14/830,163

(22) Filed: Aug. 19, 2015

(51) Int. Cl. G06F 3/0484; H04L 12/58; G06T 11/00; G06F 3/0481; G06F 3/0482; G06T 11/20

(52) U.S. Cl. CPC G06F 3/04845; G06F 3/0482; G06F 3/04842; G06T 11/20; G06T 11/001; G06F 3/04817; H04L 51/10

(57) ABSTRACT

Systems, devices and methods are directed toward preserving an interface displayed at a communication device, and then transmitting the preserved image to a recipient. An interface is initially displayed to a user, at a communication device, illustrating various information to the user. When desired to share the information with the recipient, the user provides a capture command to the communication device for all or part of the information in the interface. In response, the communication device captures an image of the interface relating to the capture command. The user can then transmit the captured image to the recipient, without storing the image in nonvolatile memory of the communication device.

### FIELD

The present disclosure generally relates to systems and methods for use in preserving interfaces displayed at communication devices, and then for use in transmitting the interfaces to desired recipients, without storing the interfaces in memory of the communication devices.

### BACKGROUND

This section provides background information related to the present disclosure which is not necessarily prior art.

Communication devices, whether portable or static, have become pervasive. The communication devices can be used for a variety of activities, including those relating to work, entertainment, and even financial transactions. Occasionally, users review certain information, through applications at their communication devices (e.g., through web-based applications, programs, etc.). At times, the users desire to save screen shots of the information, viewed at the communication devices, to provide the information to others, or to ask questions about the content of the information displayed at the screens, or for other purposes, such as customer support or troubleshooting. It is known to execute a screen shot at a computing device, by which a snapshot of the screen, as displayed to a user, is captured, and by separate used input, saved to memory of the computing device. For example, on a smartphone, a screen shot may be stored in nonvolatile memory, such as, for example, the “camera roll” of the smartphone, which stores the snapshot taken by the smartphone as a picture. Other options, such as “Print Screen,” with a resulting screen image pasted to a document, or to a Microsoft Paint® canvas, may also result in the image being stored to the computing device. The image may then be pulled from the memory, by the user, and attached to an electronic mail (email) message or SMS text message, and sent to another individual.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in preserving interfaces displayed at communication devices and then transmitting the interfaces to desired recipients;

FIG. 2 is a block diagram of an exemplary computing device that may be used in the system of FIG. 1;

FIG. 3 is an exemplary method, suitable for use with the system of FIG. 1, for preserving and transmitting to a recipient an interface displayed at a communication device; and

FIGS. 4-6 are example interfaces that may be displayed in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Often, when users are viewing information at communication devices, e.g., at laptops, tablets, smartphones, etc., the users may be inspired to share the information with others, or inquire about the information from others. In response, for example, the users take screen shots using the camera feature on the communication devices, etc., and then send images of the screen shots through email or text to recipients. In so doing, the images are stored to the communication devices, and in nonvolatile memory, and later may be accessed by the users or other users of the devices (including unauthorized users). Even when the images are deleted, the images generally remain in the devices and are recoverable, either from memory, or from the email or text application through which they were sent. The systems and methods herein provide for capturing an image of an interface displayed at an output device of a communication device (e.g., a LED display, etc.), and transmitting the image to a recipient, without storing the image in nonvolatile memory of the communication device. As such, once the image is sent, the image no longer exists on the communication device at a particular location, to be accessed by others (i.e., it is not retrievable by the user or by other users or by other applications on the communication device). For images containing confidential, or financial, or otherwise secret or personal information, the user of the communication device is therefore protected from the images being inadvertently stored in unnecessary, potentially unsecured, locations. In addition, the systems and methods herein may further permit the user to draw on, or otherwise edit or alter, the image, prior to sending it to the recipient, to designate particular areas of the interface captured in the image, or information contained therein, of emphasis (or interest) to the recipient.

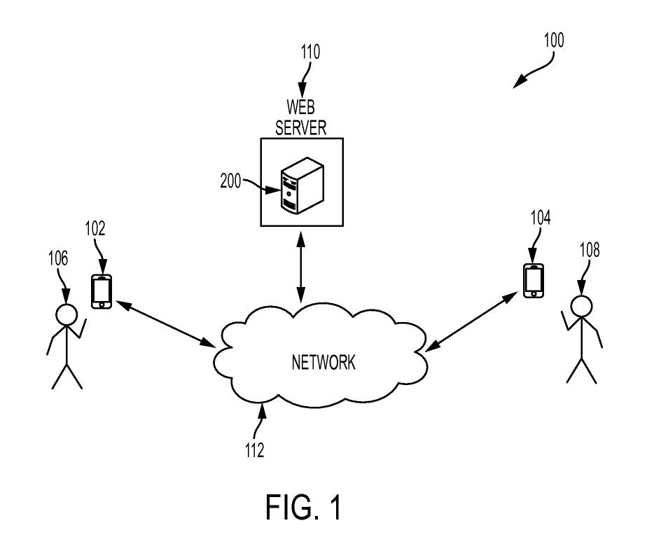

FIG. 1 illustrates an exemplary system 100, in which one or more aspects of the present disclosure may be implemented. The system 100 is suitable for use in preserving interfaces displayed at communication devices and then transmitting images of the interfaces to desired recipients, without storing the images in nonvolatile memory of the communication devices. Although components of the system 100 are presented in one arrangement, it should be appreciated that other exemplary embodiments may include the same or different components arranged otherwise, for example, depending on interactions and/or relationships between the various components, manners of transmitting data, etc.

The illustrated system 100 generally includes communication devices 102 and 104, and users 106 and 108 associated with the communication devices 102 and 104, and a web server 110. The communication devices 102 and 104 and the web server 110 are coupled via network 112. The network 112 may include, without limitation, a wired and/or wireless network, one or more local area network (LAN), wide area network (WAN) (e.g., the Internet, etc.), mobile network, other networks as described herein, and/or other suitable public and/or private networks capable of supporting communication between the communication devices 102 and 104. In one example, the network 112 includes multiple networks, where different ones of the multiple networks are accessible to different ones of the users 106 and 108 via their communication devices 102 and 104.

In the system 100, the communication devices 102 and 104 are illustrated as cellular phones. However, one or more of the communication devices 102 and 104 may include (or may be) another suitable device in other embodiments, for example, a personal digital assistant (PDA), a tablet, etc. In addition, the system 100 may similarly include (or support) other computing devices, such as, for example, workstations, other personal computers, etc., associated with users. Further, while only two users 106 and 108 and two communication devices 102 and 104 are shown in the system 100 in FIG. 1, it should be appreciated that a different number of users and/or communication devices may be included in other embodiments.

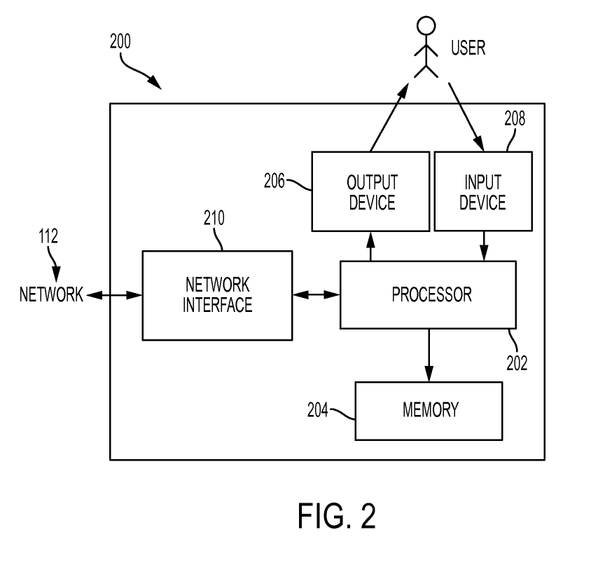

FIG. 2 illustrates an exemplary computing device 200 that can be used in the system 100 of FIG. 1. For illustration, the communication devices 102 and 104 in the system 100 are each consistent with computing device 200. The web server 110 of the system 100 is also illustrated as a computing device consistent with computing device 200. However, the system 100 and its components should not be considered to be limited to the computing device 200, as different computing devices and/or arrangements of computing devices may be used. In addition, different components and/or different arrangements of components (other than illustrated in FIG. 2) may be used in other computing devices. Further, in various exemplary embodiments, the computing device 200 (and, thus, one or more of the communication devices 102 and 104 in FIG. 1) may include multiple computing devices located in close proximity, or distributed over a geographic region, so long as the computing devices are specifically configured to function as described herein.

As shown in FIG. 2, the computing device 200 generally includes a processor 202, and a memory 204 coupled to the processor 202. The processor 202 may include, for example (and without limitation), one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. In addition, the processor 202 may be a single core processor, a multi-core processor, and/or multiple processors distributed within the computing device 200. In various embodiments, the processor 202 and memory 204 are integrated. The above is exemplary only, and is thus not intended to limit in any way the definition and/or meaning of processor.

The memory 204 of computing device 200, as described herein, is one or more devices that enable information, such as executable instructions and/or other data, to be stored and retrieved. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, tapes, hard disks, and/or any other type of volatile or nonvolatile physical or tangible computer-readable storage media. Further, in this exemplary embodiment, the memory 204 specifically includes both volatile memory and non-volatile memory, with certain operations utilizing and/or storing data in the memory 204 as described herein. Further, the memory 204 may be configured to store, without limitation, program applications, and other types of data suitable for use as described herein.

In various embodiments, computer-executable instructions may be stored in the memory 204 of the computing device 200 for execution by the processor 202 to cause the processor 202 to perform one or more of the functions described herein, such that the memory 204 is a physical, tangible, and non-transitory computer-readable storage media. It should be appreciated that the memory 204 may include a variety of different memories, each implemented in one or more of the functions or processes described herein.

With continued reference to FIG. 2, the illustrated computing device 200 also includes an output device 206 and an input device 208, each coupled to the processor 202.

The output device 206 outputs, or presents, to one of the users 106 and 108 by, for example, displaying, audibilizing, and/or otherwise outputting desired data. In some embodiments, the output device 206 comprises a display device such that various interfaces (e.g., applications, webpages, etc.) may be displayed at computing device 200, and in particular at the display device, to display such data, etc. And in some examples, the computing device 200 may cause the interfaces to be displayed at a display device of another computing device, including, for example, a server hosting a website having multiple webpages, etc. With that said, output device 206 may include, without limitation, a liquid crystal display (LCD), a light-emitting diode (LED) display, an organic LED (OLED) display, an “electronic ink” display, speakers, combinations thereof, etc. In some embodiments, output device 206 includes multiple units or devices.

The input device 208 is coupled to the processor 202 and receives input as desired. For example, the input device 208 may receive input from one of the users 106 and 108, etc. The input device 208 may include one or more of a keyboard, a pointing device, a mouse, a stylus, a touch sensitive panel (e.g., a touch pad or a touch screen, etc.), a camera, another computing device, an audio input device, etc. In some exemplary embodiments, the input device 208 of the computing device 200 may function as both an input device and an output device (and vice versa), for example, a touchscreen, such as that included in a tablet, a smartphone, or similar device. For example, a touch screen, such as that included in a tablet, a smartphone, or similar device, may behave as both an output device and an input device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

With reference again to FIG. 1, the communication device 102 associated with the user 106 includes a capture engine (not shown) defined by executable instructions, which specifically configure the communication device 102 to capture an image of an interface displayed at the communication device 102 and then transmit the image to a recipient, for example, to the user 108 (and particularly to the communication device 104 associated with the user 108). More specifically, the capture engine is loaded into volatile memory, such as, for example, RAM in the communication device 102, and executed by the processor 202. Uniquely, by use of the capture engine, the image that is captured can be transmitted by the communication device 102, yet not stored in the non-volatile memory of the communication device 102.

Specifically, while the image may be placed in volatile RAM, in the memory 204, and/or in the processor 202, for example, when the computer capture engine instructions cause the processor 202 to operate, as described herein, the image is only known to the capture engine. The image is not defined in a manner by which one or more other applications, or even an operating system of the communication device 102, can access it. Instead, the applications, and specifically the operating system, of the communication device 102 are unable to access, pull, store and/or otherwise use the image in non-volatile memory except as described herein. The image would only be retrievable, apart from the capture engine, by a memory dump, during maintenance of the communication device 102 (without an index instructing the reconstruction of the image from memory 204) and/or by malicious software (e.g., virus, malware, etc.), which operate in consistent with the intended use of the communication device 102 and specifically its operating system.

Accordingly, after being used by the capture engine, the image is lost (e.g., due to power cycle, etc.) and/or overwritten by the operation of the capture engine, or one or more other applications in the communication device 102, i.e., it is no longer preserved by the capture engine, such that the image is not recognized and/or accessible to any application in the communication device 102. More generally, the capture engine operates to store the image in volatile memory, without regard to a prior captured image (i.e., the capture engine does not preserve a prior image). As such, the captured image may potentially overwrite a part or all of the prior captured image.

As indicated above, the capture engine is defined by executable instruction, which cause the processor 202 to capture the image and return the image to volatile memory so that it may be edited (as described below) and/or transmitted. The following are exemplary instructions for at least part of the capture engine, by which the image is captured:

```
NSString *jpgPath = [NSTemporaryDirectory( )
stringByAppendingPathComponent:path];
CGRect imageRect;
CGRect screenRect = [[UIScreen mainScreen] bounds];
if (NULL != UIGraphicsBeginImageContextWithOptions)
UIGraphicsBeginImageContextWithOptions(imageRect.size, NO, 0);
else
UIGraphicsBeginImageContext(imageRect.size);
CGContextRef ctx = UIGraphicsGetCurrentContext( );
[[UIColor blackColor] set];
CGContextTranslateCTM(ctx, 0, 0);
CGContextFillRect(ctx, imageRect);
    if ([webView
respondsToSelector:@selector(drawViewHierarchyInRect:after-
ScreenUpdates:)]) {
      [webView drawViewHierarchyInRect:webView.bounds
afterScreenUpdates:YES];
      }
    else {
      [webView.layer renderInContext:ctx];
      }
UIImage *image = UIGraphicsGetImageFromCurrentImageContext( );
    NSString* imageData = [UIImagePNGRepresentation(image)
base64EncodedStringWithOptions:NSDataBase64Encoding64Character-
LineLength];
UIGraphicsEndImageContext( );
CDVPluginResult* pluginResult = nil;
    NSDictionary *jsonObj = [ [NSDictionary alloc]
initWithObjectsAndKeys : imageData, @“Path”, @“true”,
@“success”, nil ];
    pluginResult = [CDVPluginResult resultWithStatus:CDV
CommandStatus_OK messageAsDictionary:jsonObj];
```

Conversely, the capture engine is defined by executable instructions, which cause the processor 202 to call the image from volatile memory (within memory 204) and associate the image with a volatile memory variable upon which the engine may further operate. By these instructions, the capture engine gives a file name to the image, which is used, by the capture engine, as a reference by which to append the image to a message (e.g., an email, etc.), to the recipient (e.g., to user 108, etc.). The given file name is not a public file name within the communication device 102, such that it is not known to any other applications in the communication device 102. Thus, the stored image is inaccessible to and/or may not be recalled by the other applications. The captured image is not stored in any non-volatile memory in the communication device 102 in any accessible manner (except by the capture engine). The following are exemplary instructions for at least part of the capture engine, by which the capture engine gives a file name to the image:

```
module.exports = {
save:function(callback,format,quality, filename)
        {
          format = (format || ‘png’).toLowerCase( );
          filename = filename ||
‘screenshot_’+Math.round((+(new Date( )) + Math.random( )));
          if(formats.indexOf(format) === −1)
              {
                return callback &&
                callback(new Error(‘invalid format ’+format));
              }
          quality = typeof(quality) !== ‘number’?100:quality;
          exec(function(res) { callback && callback(null,res); },
function(error){ callback && callback(error);},“Screenshot”,
“saveScreenshot”,[format, quality,filename]);
      },
  URI:function(callback, quality)
        {
    quality = typeof(quality) !== ‘number’?100:quality;
    exec(function(res){ callback && callback(null, res);},
function(error){ callback && callback(error);}, “Screenshot”,
“getScreenshotAsURI”, [quality]);
    }
};
```

Further, the communication device 102 is configured to connect to web server 110 located remotely from the communication device 102, but coupled thereto by the network 112. The web server 110 offers one or more web services to the communication device 102 to perform one or more of the operations described herein. In particular, the communication device 102 is configured to invoke one or more web services available through the web server 110 to transmit the captured image to the user 108. Additionally, in multiple embodiments, the communication device 102 may be configured to invoke one or more web services for additional or further operations described herein including, for example, editing or drawing on a captured image. By use of the web server 110, for example, once the image is transmitted to the user 108, the image is no longer present on the communication device 102 (i.e., the image is not permanently stored, such that it may be recalled or retrieved by the user 106 or other users, etc.). In various embodiments, the communication device 104 associated with the user 108 may be similarly configured to, for example, receive and/or view the image from the communication device 102.

In general, the communication device 102, and particularly the processor 202 thereof, is capable of causing multiple different interfaces to display at the output device 206, pursuant to known operations of the communication device 102. For example, interfaces may be displayed through use of the communication device's operating system and/or applications that may be stored in memory of the communication device 102 or available through the web server 110. As will be described more in connection with method 300, when the user 106 desires to share one of the multiple different interfaces, or a portion thereof, with the user 108, he/she can use the communication device 102 to capture an image of the interface being displayed to the user 106, at the output device 206, and transmit the captured image to the user 108. In addition, through the communication device 102, the user 106 can draw on, or otherwise edit or alter, the captured image, prior to transmitting it to the user 108. As such, the user 106 can designate particular areas of the image, or information contained therein, of emphasis (or interest) to the user 108.

The application at the communication device 102 with which the multiple different interfaces are associated may include any different type of application, which displays one or more interfaces, at the communication device 102, to permit the user 106 to access the information, or perform one or more tasks, etc. In particular, for example, the application may include a financial-type application, through which a user may be able to access banking, payment account, other accounts, or other investment information, or other information for or related to the user. Further, the application may include a background application that operates in conjunction with other primary applications, so that when the other primary applications are accessed, the background application is also accessed and enables the various operations disclosed herein for interfaces displayed by the primary applications. Moreover, the operations described herein, at the communication device 102, may be provided through a capture module (i.e., as defined by computer-executable instructions), which may be incorporated with applications (e.g., the primary applications above, etc.), or may be a stand-alone application itself.

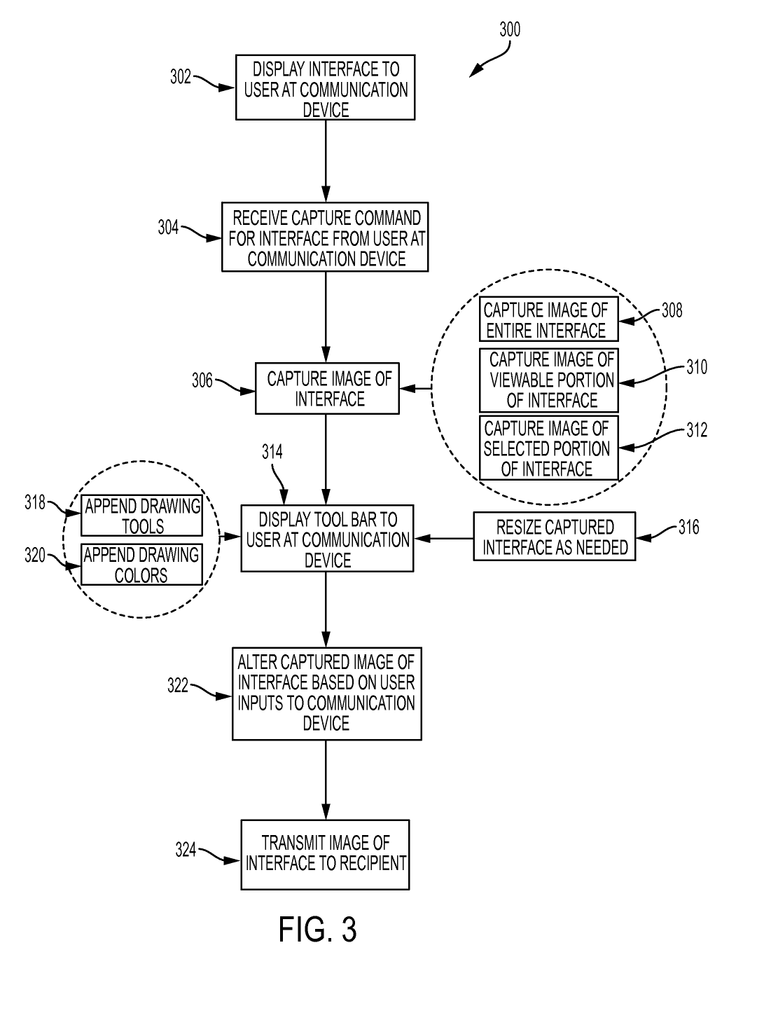

FIG. 3 illustrates exemplary method 300 for use in preserving an image of an interface displayed at a communication device and then transmitting the image of the interface to a recipient, without storing the image of the interface in nonvolatile memory of the communication device. The exemplary method 300 is described as implemented in the capture engine of communication device 102 (e.g., by executable instruction operating the processor 202, etc.), with further reference to the communication device 104, the users 106 and 108, and the web server 110. Further, for purposes of illustration, the exemplary method 300 is described herein with reference to the computing device 200. But, the methods herein, including method 300, should not be understood to be limited to the exemplary system 100 or the exemplary computing device 200, just as the systems and computing devices herein should not be understood to be limited to the exemplary method 300.

As shown in FIG. 3, in the method 300, an interface is displayed to the user 106, at 302, at the output device 206 of the communication device 102. The interface is generally associated with an application executed at the communication device 102. The application may display, through the interface, information contained in the communication device 102, or information retrieved by the communication device 102 and/or provided to the communication device 102 through one or more web services or computing devices associated with network 112 (not shown). The application, for example, may display an interface with certain financial information, or other information to the user 106, as indicated above. The interface may be displayed to the user 106 upon receipt of the information at the communication device 102, or upon activation of the particular application by the user 106, or otherwise.

When the user 106 desires to share the interface, or information included in the interface, with others (such as the user 108), the user 106 enters a capture command, via the input device 208 of the communication device 102. For example, the capture command may be provided to an icon, or other input field within the interface, and/or viewable to the user at the output device 206. In turn, the communication device 102 (and specifically the capture engine) receives the capture command, at 304, and captures an image of the interface, at 306. In so doing, the communication device 102 puts the image in RAM memory 204, in this example, but does not store the image in nonvolatile memory.

In connection with capturing the image of the interface, at 306, the communication device 102 may capture an image of the entire interface, at 308. Or, the communication device 102 may capture an image of a portion of the interface that is viewable to the user 106, at the output device 206, at 310. When only a portion of the interface is captured, other portions of the interface not viewable to the user 106, for example, that require the user 106 to scroll along the interface to view, for example, may not be captured. Still further, the communication device 102 may capture an image of a part of the interface that is particularly selected (e.g., based on a capture-portion input to the communication device, etc.), by the user 106, at 312. Such a part may include, for example, a part of the interface containing specific information of interest to the user 106, or of potential interest to user 108, etc.

In a variety of embodiments, upon receiving the capture command from the user 106, the communication device 102 (and specifically the capture engine) may provide the user 106 with options to either capture an image of the entire interface, an image of the entire viewable part of the interface, or an image of a user-selected part of the interface. Such options may automatically display to the user 106, at the output device 206, upon receipt of a capture command, or they may be available to the user 106 through a menu or tool bar, etc. In connection with capturing a user-selected part of the interface, the communication device 102 may cause a selection tool to display to the user 106 (e.g., a pointer, etc.). The user 106 can then use the selection tool to identify, or select, a particular part of the interface (i.e., a capture-portion input), defining the desired content to capture in the image (e.g., via touching the input device 208 and moving the selection tool to outline the capture portion, etc.). The capture-portion input, which is then received by the communication device 102, may be less than the entire interface or less than a part of the interface viewable to the user 106, at the output device 206.

In various embodiments, at 306, the communication device 102 (and specifically the capture engine) captures only application-based content of the interface. The communication device 102 excludes other content viewable to the user 106, at the output device 206, but not associated with the application. The excluded content may include, for example, a smartphone status header indicative of features of the communication device 102, such as, for example, a clock, a temperature reading, a date, a location, a battery strength indicator, a signal strength indicator, icons for other applications or alerts, etc.

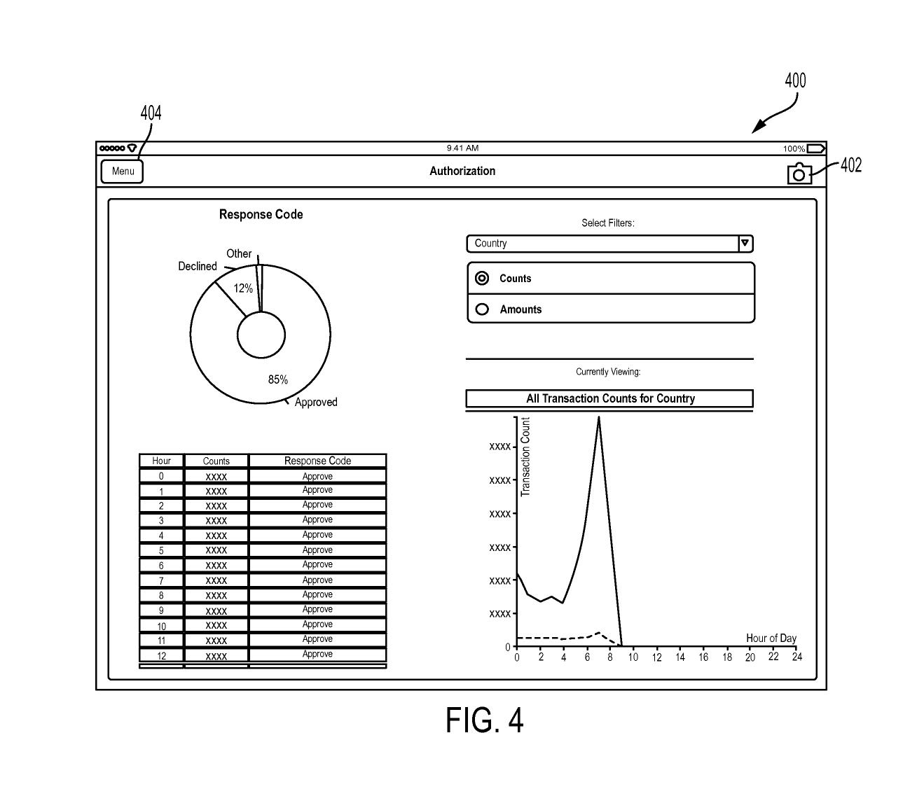

FIG. 4 illustrates an example interface 400 that can be used, in connection with the method 300, to display information to the user 106 at the communication device 102 relating, for example, to financial transaction data. The interface 400 is associated with a document viewing application stored in memory 204 of the user's communication device 102. In the example interface 400, a capture icon 402 in the form of a camera is disposed along an upper margin of the interface 400, which the user 106 can select, via the input device 208 (e.g., by touching a touchscreen, i.e., a combined output device 206 and input device 208, of the communication device 102, etc.), which indicates a capture command for the interface 400. In response, the communication device 102 receives the capture command, at the capture icon 402, at the interface 400. The interface 400 also includes a menu button 404, for example, to allow the user 106 to select among various capture options for the interface 400 that occur upon selection of the capture icon 402, for example, capturing an image of the entire interface 400, capturing an image of the viewable portion of the interface 400, or capturing an image of a user-selected portion of the interface 400.

With reference again to FIG. 3, after capturing the image, the communication device 102 (i.e., the processor 202 executing the capture engine) displays a tool bar to the user 106 at the output device 206, at 314 (e.g., through the capture module, etc.). In so doing, the communication device 102 also resizes, in this embodiment, the image, at 316, as needed to allow for both the image of the interface, as captured, and the tool bar to be displayed together at the output device 206 of the communication device 102, generally without overlapping. The tool bar may include, in various embodiments, a number of different tools which, when selected by the user 106, via the input device 208, permit drawing on, editing or otherwise processing the captured interface. For example, in the method 300, the tool bar appends one or multiple different drawing tools, at 318, to the tool bar, such as a pen, a pencil, a marker, a paint brush, etc. (potentially of varying sizes as well, etc.), and further appends one or multiple different drawing colors, at 320, such as black, red, yellow, green, blue, etc. The number of different optional drawing tools and/or colors appended to the tool bar may be based on a default setting, or in some embodiments, based on the user's preferences (e.g., selected from the menu 404, etc.). In further embodiments, the tool bar may include the same, similar, additional or different tools appended thereto, for example, a keyboard, an eraser, selectable predefined shapes, comments, flags, and/or text boxes, etc.

Through the tool bar, the user 106 can edit or otherwise alter the captured image, for example, via user inputs to the input device 208. In connection therewith, the communication device 102 captures the alterations made by the user 106, at 322. For example, the user 106 can select one of the drawing tools and drawing colors from the tool bar, and then provide one or more drawing annotations (broadly, drawing inputs) on the captured image, at the input device 208, for example. In turn, the communication device 102 receives and causes markings, consistent with the drawing inputs by the user 106, to be overlaid on the captured image.

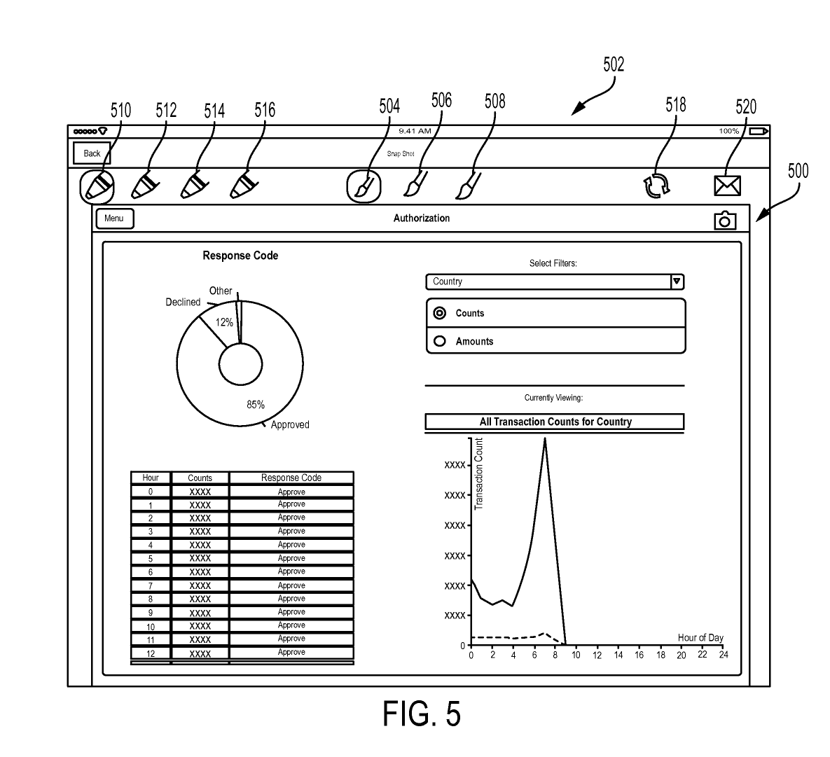

FIG. 5 illustrates an image 500 of the interface 400 of FIG. 4 after being captured, for example, at 306, in the method 300. As shown, a tool bar 502 is positioned generally above the captured image 500, but without overlapping the captured image 500, in this embodiment. In addition, three different drawing tools 504-508 and four different drawing colors 510-516 are provided in the tool bar 502. In this example, the drawing tools 504-508 are each illustrated as paint brushes, with each paint brush having a progressively larger size. Also in this example, the tool bar 502 further includes an undo edit button 518, for example, that can be used to return the image 500 of the interface 400 to an original state, for example, after making alterations to the image 500 of the interface 400 (e.g., to remove or undo any alterations made to the image 500, etc.), and a mail button 520 for transmitting the image 500 of the interface 400, when desired.

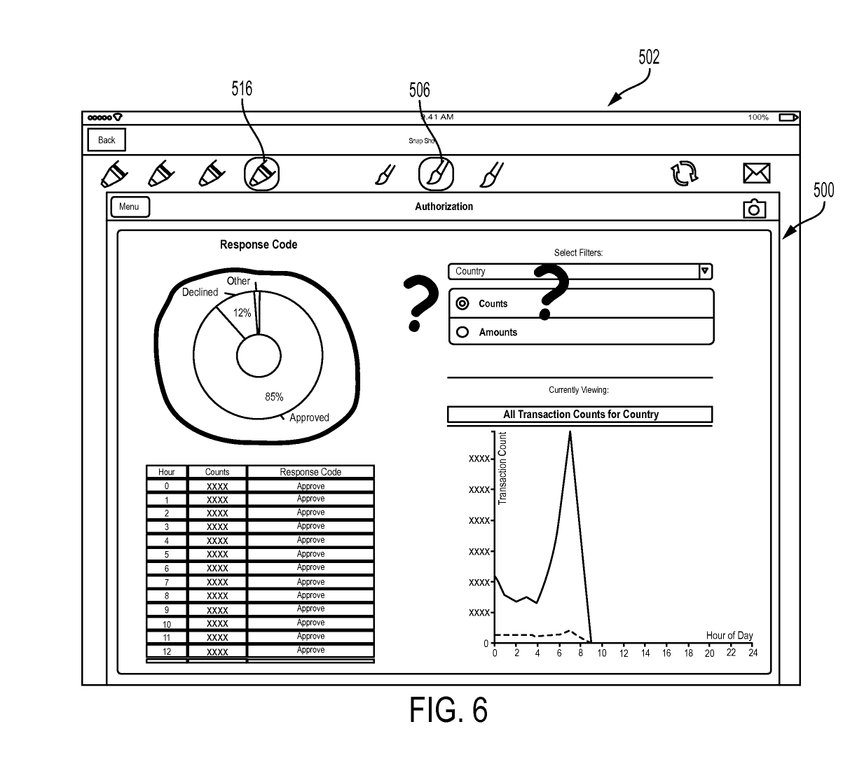

FIG. 6 illustrates example alterations made to the image 500, by the user 106 at the communication device 102, using the drawing tool 506 and the drawing color 516, with the alterations generally overlaid on the captured image 500. The alterations include a circle extending around a portion of the image 500, and question marks adjacent the circle.

Referring again to FIG. 3, once desired alterations are made to the captured image, at 322, the image, as altered, can be transmitted, by the communication device 102 (and specifically the capture engine) to a desired recipient, at 324. In particular, the tool bar displayed by the communication device 102 may include a transmittal icon (see, e.g., the mail button 520 in FIG. 6) that the user 106 can select when desired to transmit the image, for example, to the user 108. Upon selection of the transmittal icon, the communication device 102 receives the (and specifically the capture engine) transmittal input and causes a transmittal interface to display, at the output device 206. The user 106 can then enter an indication of the recipient, or, in this example, the user 108, via the input device 208, such as, for example, a username, a screen name, an email address or a phone number, and, optionally, a corresponding message. The image and message are then transmitted as desired, for example, via email or SMS text, to the user 106, via the web server 110.

In this embodiment, the communication device 102 (i.e., the processor 202 executing the capture engine), to display the transmittal interface, invokes a web service hosted at web server 110. Specifically, the web service is called (e.g., through an application program interface (API), etc.), by the communication device 102, in response to the transmittal input. Stated otherwise, the communication device 102 provides the image to a web service, hosted at web server 110, which provides the transmittal interface, email, or other message, and facilitates the transmission. The communication device 102, in this embodiment, is omitted from the transmittal operation. As such, once the image is transmitted to the user 108, the image, as captured, has not been stored in non-volatile memory of the communication device 102, and in effect, no longer exists on the communication device 102, to be accessed by the user 106 or others. The communication device 102, based on a response from the web server 110, in this embodiment, then causes a confirmation message to display to the user 106, at the output device 206 of the communication device 102, confirming that the image and message have been transmitted.

Further, the communication device 102, in response to one or more user commands, repeats one or more of the steps of method 300. After the image is transmitted at 324, the communication device 102 (and specifically the capture engine) does not act to preserve a prior captured image. Rather, the capture engine utilizes the volatile memory as permitted by the processor 202, which may result in the prior captured image being overwritten, either by the capture engine or another application included in the communication device 102. Once overwritten (or power to the volatile memory is cycled/lost), the image is no longer present and/or accessible to the capture engine or other applications within the communication device 102.

In this manner, a user (e.g., user 106, etc.) is permitted to capture and transmit an image of an interface (or part thereof), without being concerned with the image remaining stored in the communication device 102. In various examples, financial information, or other private, confidential, and/or secret information may be included in images of interfaces, which are sent to recipients, without creating a risk that the communication device is a potential access point for the information in the interface, by, for example, other users accessing the communication device (whether authorized or unauthorized).

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein, for example, in the claims, etc.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) causing an interface to be displayed at an output device associated with a communication device, (b) receiving a capture command from a user, to the interface, via an input device associated with the communication device, (c) capturing an image of the interface in response to the capture command, and (d) transmitting the image to a recipient, without storing the image in nonvolatile memory of the communication device.

And/or, the technical effect may further be achieved by performing any other operations recited in the claims below, or described in the description above.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” or “associated with” another feature, element or layer, it may be directly on, engaged, connected, coupled, or associated with/to the other feature, element or layer, or intervening features, elements or layers may be present. In contrast, when feature, element or layer is referred to as being “directly on,” “directly engaged to,” “directly connected to,” “directly coupled to,” “directly associated with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element or operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in preserving an interface displayed at a communication device, the method comprising:
causing an interface to be displayed at an output device associated with a communication device;
receiving, via an input device associated with the communication device, a capture command from a user, to the interface;
capturing, by the communication device, an image of the interface in response to the capture command; and
transmitting, from the communication device, the image to a recipient, without storing the image in nonvolatile memory of the communication device, whereby the image is inaccessible to one or more other applications included in the communication device.

2. The method of claim 1, further comprising storing the image only in a volatile memory of the communication device, after capturing said image.

3. The method of claim 2, further comprising overwriting at least part of said image stored in the volatile memory, after transmitting the image, with a subsequently captured image and/or by operation of the one or more other applications.

4. The method of claim 1, further comprising altering the captured image, based on at least one user input received via the input device, prior to transmitting the image to the recipient; and
wherein transmitting the image includes transmitting the altered image.

5. The method of claim 1, further comprising:
after capturing an image of the interface, causing a tool bar to be displayed at the output device, the tool bar including at least one drawing tool;
receiving, via the input device, a selection of the at least one drawing tool; and
causing a drawing consistent with a drawing input received via the input device to be overlaid on the captured image;
wherein transmitting the image includes transmitting the image with the overlaid drawing.

6. The method of claim 5, wherein the tool bar further includes multiple colors associated with the at least one drawing tool; and
further comprising receiving, via the input device, a selection of at least one of the multiple colors, prior to receiving the drawing input, such that the drawing to be overlaid on the captured image is in the selected at least one of the multiple colors.

7. The method of claim 1, wherein capturing the image includes capturing only application-viewable content at the output device and/or capturing a selected portion of the interface; and
further comprising resizing and displaying the captured imaged, at the output device, such that the captured image and tool bar are displayed together at the output device without overlapping.

8. The method of claim 1, further comprising receiving an indication of the recipient via the input device; and
wherein transmitting the image includes sending the image, via at least one of electronic mail and SMS text, to the recipient, based on said indication.

9. A communication device comprising:
an output device;
a nonvolatile memory including a capture engine defined by computer-executable instructions; and
a processor coupled to the memory and the output device, and configured, by the capture engine, to:
cause multiple interfaces to display at the output device, each of the interfaces associated with an application, and each of the interfaces including a capture icon;
capture an image of one of the multiple interfaces displayed at the output device in response to a capture command, from a user, to the capture icon; and
transmit the captured image to a recipient, without storing the captured image in the nonvolatile memory, whereby the captured image is only defined to the capture engine such that the captured image is inaccessible to one or more other applications included in the communication device.

10. The communication device of claim 9, further comprising a volatile memory coupled to the processor; and
wherein the processor is further configured, by the capture engine, to store the captured image in the volatile memory, such that the stored image is accessible to the capture engine.

11. The communication device of claim 9, wherein the processor is further configured, by the capture engine, to cause a confirmation message to display at the output device, when the image has been transmitted.

12. The communication device of claim 9, wherein the application includes a web-based application for accessing payment account information; and
wherein the processor is further configured to, by the capture engine, in response to the capture command:
cause a tool bar to display at the output device, the tool bar including at least one drawing tool option and at least two color options;
receive a selection of one of the at least two color options; and
cause the image to be altered, in the selected one of the at least two color options, consistent with a drawing input from the user.

13. The communication device of claim 9, wherein the processor is further configured, by the capture engine, to:
cause a transmittal interface to display at the output device;
receive a message from the user at the transmittal interface; and
transmit the message with the captured image to the recipient.

14. The communication device of claim 9, wherein the output device is also an input device, and wherein the capture command is received, by the processor, at the input device.

15. The communication device of claim 9, wherein the processor is further configured, by the capture engine, to connect to a web server, at a server located remotely from the communication device; and
wherein the processor is configured, by the capture engine, to transmit the captured image, via the web service.

16. A non-transitory computer-readable storage media including computer-executable instructions that, when executed by at least one processor, cause the at least one processor to:
display multiple interfaces associated with an application, each interface including a capture icon;
in response to a capture command, at the capture icon, capture an image of a displayed one of the multiple interfaces and store the captured image only in volatile memory;
display the captured image to a user;
alter the captured image, based on one or more drawing inputs from the user; and
transmit the captured image, as altered by the user, to a recipient.

17. The non-transitory computer-readable storage media of claim 16, wherein the computer-executable instructions, when executed by the at least one processor, cause the processor to store the capture image in available volatile memory without regard to a prior captured image.

18. The non-transitory computer-readable storage media of claim 16, wherein the computer-executable instructions, when executed by the at least one processor, further cause the at least one processor to display a tool bar to the user, along with the captured image, from which the user is permitted to select at least one drawing tool to provide the one or more drawing inputs.

19. The non-transitory computer-readable storage media of claim 18, wherein the captured image includes only application-viewable content associated with the interface; and
wherein the computer-executable instructions, when executed by the at least one processor, further cause the at least one processor to resize and display the captured image such that the captured image and the tool bar are displayed together without overlapping.

20. The non-transitory computer-readable storage media of claim 16, wherein the computer-executable instructions, when executed by the at least one processor, further cause the at least one processor to:
display a transmittal interface to the user;
receive a message from the user at the transmittal interface; and
transmit the message with the captured image to the recipient.
